(19) United States
(12) Patent Application Publication
(10) Pub. No.: US 2010/0228391 A1
(43) Pub. Date: Sep. 9, 2010

(54) System and method for inter-machine combination discount vend

(75) Inventor: Scott Hudis, Stillwater, MN (US)

Correspondence Address: DOCKET CLERK, P.O. DRAWER 800889, DALLAS, TX, 75380, US

(73) Assignee: CRANE CO., Stamford, CT (US)

(21) Appl. No.: 12/380,952

(22) Filed: Mar. 5, 2009

(51) Int. Cl. G06F 17/00; B65D 83/00

(52) U.S. Cl. 700/241; 221/282

(57) ABSTRACT

A system and method for providing a combination vend operation. The system and method include a first (parent) vending machine operable to discount a product when an associated product is selected. The combination vend operation may be performed when the discounted product and the associated product are in different vending machines. The same of first (parent) vending machine directs a second (child) vending machine to dispense the discounted product during the combo vend operation. A consumer may purchase the discounted product at the discounted price after or while purchasing the associated product.

### TECHNICAL FIELD

This disclosure is generally directed to consumer product vending machines and more particularly to systems and methods for interfaces for vending machines.

### BACKGROUND

A vending machine is a machine that provides various snacks, beverages and other products to consumers by vending products without a cashier. Items sold via vending machines can vary by country and region. Vending machines typically utilize a push button interface that is capable of accepting money in paper or coin form. A consumer may insert coins into a coin acceptor or dollar bills into a bill validator, or a combination of the two. Thereafter, the consumer typically makes a product selection by entering a product identifying code into a keypad on the face of the vending machine. If the amount of money recognized by the machine equals or exceeds the amount of money required to purchase the selected product, the machine proceeds to vend the product to the consumer. However, if the consumer has not entered enough money, or the machine not recognized the entry of enough money, no product will be vended to the consumer.

### SUMMARY

This disclosure provides a system and method for providing a consumer a combined vending machine transaction. This disclosure also provides a system and method for wireless communication between and among vending machines and between vending machines and operational management and service controllers.

A vending machine system is provided. The vending machine system includes a first vending machine capable of vending a first group of products from a first vending machine product area. The vending machine system also includes a second vending machine coupled to the first vending machine. The second vending machine is capable of vending a second group of products from a second vending machine product area in response to commands received from the first vending machine. Further, the first vending machine is configured to discount at least one product from either the first group of products or the second group of products when an associated product is selected from the other of the first group of products or second group of products.

An apparatus for vending products to a consumer is provided. The apparatus includes a product storage area; a computer readable medium; and a plurality of instructions. At least a portion of the plurality of instructions is storable in the computer readable medium. Further, when a first product is selected, the plurality of instructions is configured to cause the apparatus to discount a price of an associated product located in the product storage area, the remote product storage area, or both.

A method for vending products is provided. The method includes receiving a selection of a first product and determining a group of associated products associated to the selected product. A discount corresponding to each of the associated products is identified or at least one of the associated products is offered at a discounted price when purchased with the first product.

Other technical features may be readily apparent to one skilled in the art from the following figures, descriptions and claims.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure and its features, reference is now made to the following description, taken in conjunction with the accompanying drawings, in which:

FIG. 1 is a somewhat simplified illustration of a vending machine according to embodiments of the present disclosure;

FIG. 2 illustrates a user interface area according to embodiments of the present disclosure;

FIG. 3 illustrates a keypad interface according to embodiments of the present disclosure;

FIG. 4 illustrates a vending machine controller 400 according to embodiments of the present disclosure;

FIG. 5 illustrates a satellite vending system 500 according to embodiments of the present disclosure;

FIG. 6 illustrates a combo-discount vend operation in accordance with embodiments of the present disclosure; and

FIG. 7 is a schematic system diagram of a vending machine system having wireless communication capability according to one embodiment of the present disclosure.

### DETAILED DESCRIPTION

This disclosure provides a system and method for providing a consumer a combined vending machine transaction. This disclosure also provides a system and method for wireless communication between and among vending machines and between vending machines and operational management and service controllers.

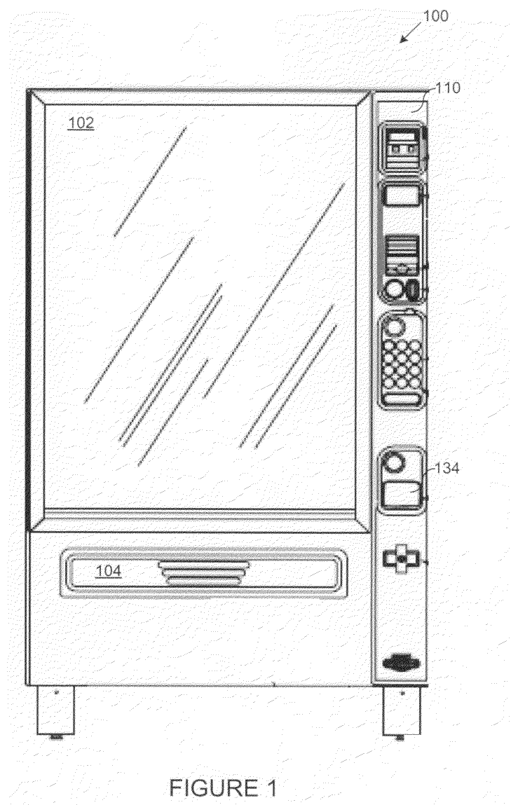

FIG. 1 is a somewhat simplified illustration of a vending machine 100 according to one embodiment of the present disclosure. The embodiment of the vending machine 100 shown in FIG. 1 is for illustration only. Other embodiments of the vending machine 100 could be used without departing from the scope of this disclosure.

The vending machine 100 has a product display and storage area 102 and a delivery door 104. Additionally, the vending machine 100 has a user interface area 110 and a change return tray 134. Depiction of the user interface area 110 along one side of the face of the vending machine 100 is exemplary only and should not be construed as limited to this configuration. The user interface area 110 may be located along the left side of the face of the vending machine 100. Additionally or alternatively, the user interface area 110 may be located in any other user-accessible portion of the vending machine 100. While shown adjacent to each other, in other embodiments, subsections of the user interface 110 may be located in different portions (split or separated) of the vending machine 100. The vending machine 100 may be configured to dispense a number of different products as is known in the art, including, but not limited to, beverages, snacks, electronic devices, cigarettes, and music recordings.

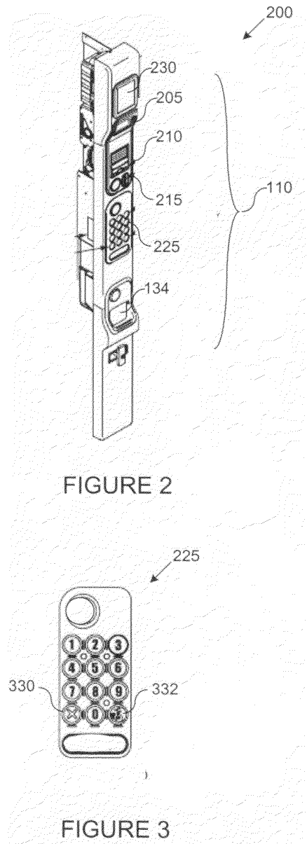

Referring now to FIGS. 2 and 3, the user interface area (hereinafter “UI”) 110 is illustrated in more detail. The embodiments of the UI 110 shown in FIGS. 2 and 3 are for illustration only. Other embodiments of the UI 110 could be used without departing from the scope of this disclosure.

The UI 100 is disposed on a front face of a control carriage 200 (also referred to as a “monetary slide”). The UI 110 includes a card validator 205, a bill validator 210, and a coin insert 215. Although only these three monetary inputs are shown, it should be understood that any suitable manner and method of payment may be incorporated as is known in the art or hereinafter discovered. Further, embodiments incorporating two or less of the card validator 205, the bill validator 210, and the coin insert 215 could be used without departing from the scope of the disclosure.

In some embodiments, the UI 110 also includes a user interface guide (hereinafter “UI guide”) (not shown). The UI guide may be one (1) unit or may be separated into two (2) or three (3) units. In some embodiments, the UI guide is a single touch screen display or the UI guide includes multiple touch screen displays. In some embodiments, the UI guide includes one or more illuminating indicators (not shown). The one or more illuminating indicators may be a visual Light Emitting Diode (hereinafter “LED”) display. Use of an LED is exemplary and it should be understood that other light emitting sources, such as, but not limited to, incandescent, plasma and fiber-optic sources may be utilized. Different ones of the illuminating indicators may utilize different source technologies and display through different wavelength spectrums (i.e., different illuminating indicators may each appear to be a different color as light is emitted or reflected via a different wavelength).

The UI 110 includes a customer keypad 225. The customer keypad 225 includes a plurality of buttons responsive to physical contact by the consumer. The customer keypad 225 may be a standard numeric keypad or it may be an alpha-numeric keypad. The buttons of the customer keypad 225 are adapted to be illuminated by LED or sources such as, but not limited to, incandescent light and fiberoptic. Each one of the plurality of buttons includes a character, or characters. In one embodiment, the character on each of the plurality of buttons is opaque while the remaining area of each of the plurality of button illuminates. In alternate embodiments, the character illuminates while the remaining area of the button is opaque. Additionally, in some embodiments, the customer keypad 225 is displayed within the touch screen display. Further, the buttons of the customer keypad are configured to be of such a size and shape so as to assist a customer in readily recognizing and contacting each one of the plurality of buttons. For example, the buttons of the customer keypad 225 may be large round buttons as well as being illuminated.

In some embodiments, the customer keypad 225 is responsive to programming such that, upon the initiation of a selection by the customer, the button, or the area representing the button if part of a touch screen display, illuminates and may remain illuminated. For example, if the customer presses a number on the customer keypad 225, the number pressed is illuminated. The characters selected by the customer may remain illuminated until the customer confirms the selection. Additionally, the characters selected by the customer may be displayed on a video display 230.

In yet additional and alternative embodiments, the keypad 225 is included in the UI Guide. In such embodiments, the UI Guide is operable to emphasize a selected number upon selection by the customer. For example, the UI Guide can increase the size of the number selected or change the color of the number selected. Additionally, the UI Guide is operable to maintain an emphasis on the numbers selected by the customer until the vend transaction is complete.

In some embodiments, the video display 230 is a two (2) inch by three and a half (3.5) inch graphic display. The display 230 shows how much money has been entered and may have an internal program for idle periods. The display 230 provides a visual indication of which product identification characters have been entered. Upon entry of the last character of the product identifier, the display 230 directs the customer to confirm their selection. For example, if the product identifiers are three-digit numbers, upon entering the third number, the display 230 directs the customer to press a specified button on the keypad 225. Further, if a selected product fails to be dispensed, the display 230 directs the customer to make another selection.

In some embodiments, after a last character of a product identifier is entered by the customer, the display 230 may prompt the customer to confirm their product selection. Additionally, if the product is unavailable, the display may prompt the customer to make another production selection or request a refund. After confirming the customer's product selection, the vending machine 100 commences a vend process.

In the vend process, the vending machine 100 cycles a dispensing mechanism (not shown) corresponding to the product identifier in order to release the selected product. As the product is released from a product tray (not shown), the product is deposited into a delivery bin (not shown). The vended product within the delivery bin is accessible via the delivery door 104.

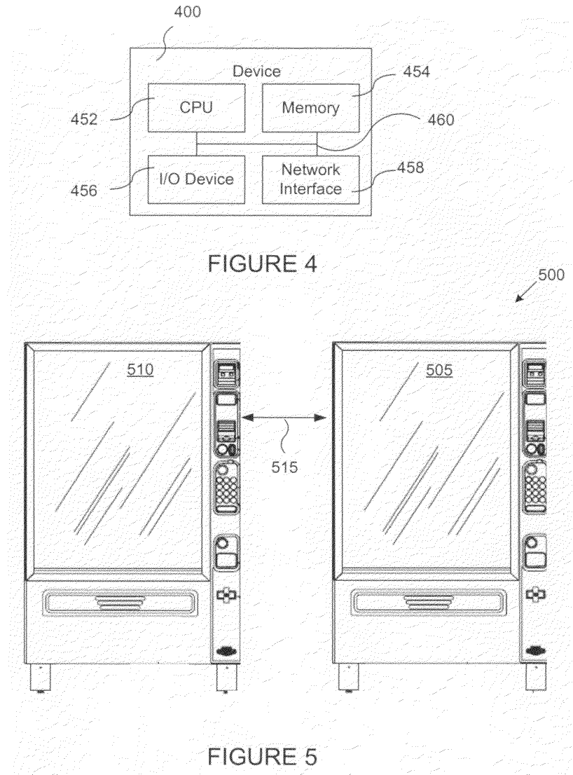

In the event that the customer determines that the correct product identifier was not entered, the customer may press (i.e. physically contact) a cancel key 330. The cancel key 330 is included within the customer keypad 225. In some embodiments, the cancel key 330 is located proximate the keypad 225 or in another location. In some embodiments, the cancel key 330 is responsive to programming such that the cancel key 330 illuminates upon the entry of any character of a product identifier. Selection of the cancel key 330 removes the entry of the product identifier from a memory (discussed in more detail herein below with respect to FIG. 4) and from the display 230.

Additionally, at any time prior to confirming the selection, the customer may request the vending machine 100 return the customer's money by depressing a coin return key 332.

The coin return key 332 is included within the customer keypad 225. In some embodiments, the coin return key 332 is located proximate the customer keypad 225 or in another user-accessible location. In some embodiments, the coin return key 332 is responsive to programming such that the coin return key 332 illuminates upon the entry of money into the coin insert 215. Selection of the coin return key 332 removes the entry of the product identifier from a memory, if entered (discussed in more detail herein below with respect to FIG. 4). Pressing the coin return key 332 causes the vending machine 100 to return any money inserted into the coin insert 215. In some embodiments, depressing the coin return key 332 results in the vending machine 100 cancelling the initiation of any transaction resulting from reading a credit card into the card validator 205 or returning any bills inserted into the bill validator 210 (and/or returning coins).

In some additional and alternative embodiments, if the customer inserts more money than is required to purchase the desired product, the display 230 is responsive to programming such that the display 230 informs the customer that excess money (i.e. change from the sale) has been, or will be, returned to the customer. For example, the customer inserts $1.00 and selects a product for sale at 75 cents. In response, the product is dispensed, 25 cents is placed in the coin return tray 134 and the display instructs the customer that the 25 cents has been placed in the return tray 134.

FIG. 4 illustrates a vending machine controller 400 according to embodiments of the present disclosure. The embodiment of the vending machine controller 400 shown in FIG. 4 is for illustration only. Other embodiments of the vending machine controller 400 could be used without departing from the scope of this disclosure.

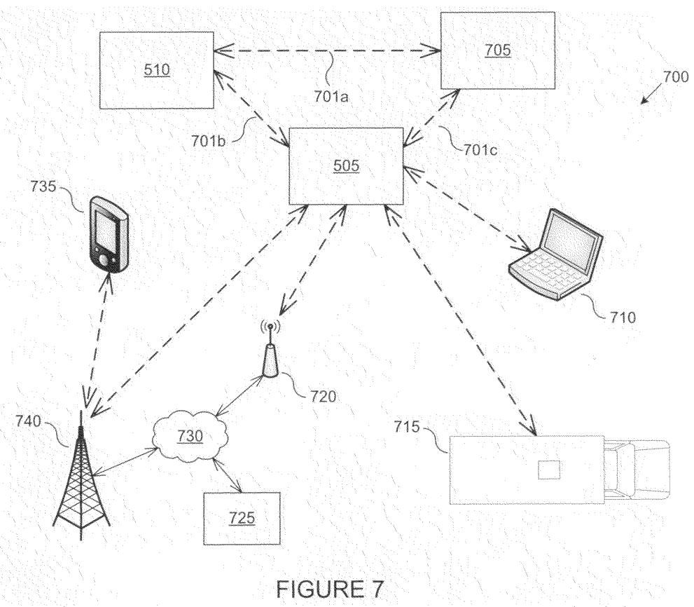

The controller 400 that functions to control or operate the UI guide 220, may be a computer, or any other device capable of transmitting, processing, and/or receiving signals via wireless and/or wireline communication links. The controller 400 includes a central processing unit (“CPU”) 452, a memory unit 454, an input/output (“I/O”) device 156, and a network interface 458. The network interface may be, for example, one or more network interface cards (NICs) that are each associated with a media access control (MAC) address. The components 452, 454, 456, and 458 are interconnected by one or more communication links 460 (e.g., a bus). It is understood that the controller 400 may be configured differently and that each of the listed components may actually represent, or include, several different components. For example, the CPU 452 may actually represent a multi-processor or a distributed processing system; the memory unit 454 can be a computer readable medium and may include different levels of cache memory, main memory, hard disks, and/or remote storage locations; and the I/O device 456 may include displays, keyboards, and the like. Alternatively, a single component may be utilized for two or more of the components illustrated. The network interface 458 enables the controller 400 to connect to a network, such as the wireless network of FIG. 7 or a wireline network.

Memory unit 454 includes programming instructions stored therein and adapted to be utilized by the CPU 452 to control the UI 110 through the operation of a satellite vending system (discussed in further detail herein below with respect to FIG. 5) the display 230, customer keypad 225, cancel key 330, and coin return key 332. Memory unit 454 is further adapted to store inputs received from the customer keypad 225 for illustration of selected product via display 230 and illumination of depressed characters on customer keypad 225.

FIG. 5 illustrates a satellite vending system 500 according to embodiments of the present disclosure. The embodiment of the satellite vending system 500 shown in FIG. 5 is for illustration only. Other embodiments of the satellite vending system 500 could be used without departing from the scope of this disclosure.

The satellite vending system 500 includes a parent (master) vending machine 505 and a child (slave) vending machine 510. Parent vending machine 505 and child vending machine 510 can be the same general structure and functionality as the vending machine 100. In one illustrative example, the parent vending machine 505 is configured to dispense cold soft drinks and the child vending machine 510 is configured to dispense snacks. It will be understood that illustration of the parent vending machine 505 is configured to dispense cold soft drinks and the child vending machine 510 is configured to dispense snacks is by way of example only, and many other configurations could be used without departing from the scope of this disclosure.

The child vending machine 510 is coupled to the parent vending machine 505 through a bidirectional communication link 515. The communication link 515 can be a wired connection (e.g., a wireline link) and/or a wireless connection (e.g., wireless link): such a wireless link may include, but not is limited to, an infrared or Radio Frequency (RF) or other RF including wireless communications in accordance with Wireless Fidelity (WiFi) IEEE 802.11, IEEE 802.16 (referred to as a “WiMAX”) Bluetooth connection, or any other suitable wireless communications interface standard. The communication link 515 enables the controller 400 of the parent vending machine 505 to communicate with the controller 400 of the child vending machine 510 and vice versa.

The parent vending machine 505 is configured to control, or interact with, vending operations of the child vending machine 510. Accordingly, the memory 454 in the parent vending machine controller 450 includes a plurality of instructions stored therein and configured to cause the parent vending machine 505 to transmit commands to the child vending machine 510 causing or allowing the child vending machine 510 to vend a product to a customer (e.g., place a selected product in the child vending machine's product delivery bin).

In alternate embodiments, the child vending machine 505 is configured to act as a second, or remote, product display and storage area 102 for the parent vending machine 510.

In some embodiments, the parent vending machine 505 is configured to discount a product vended from either the parent vending machine 505 or the child vending machine 510. In such embodiments, the parent vending machine 505 is configured to determine if a first product has been selected in one of the parent vending machine 505 or the child vending machine 510. If the first product selected has an associated product in the other vending machine 505, 510, then the parent vending machine 505 is configured to inform the customer that the associated product is being offered at a discounted price. If the customer selects the associated product, the parent vending machine 505 commences a combo-discount vend operation.

In the combo-discount vend operation, the parent vending machine 505 either vends a first product from the product display and storage area 102 or directs the child vending machine 510 to vend the first product. For example, if the first product is located within the child vending machine 510 and the associated product is located in the parent vending machine 505, the parent vending machine 505 vends the associated product and directs the child vending machine 510 to vend the first product. Additionally and alternatively, if the first product is located within the parent vending machine 505 and the associated product is located in the child vending machine 510, the parent vending machine 505 vends the first product and directs the child vending machine 510 to vend the associated product. As such, the combo-discount vend operation can be:

1) a first product in the parent vending machine and a second (associated) product in the child vending machine;

2) a first product in the child vending machine and a second (associated) product in the parent vending machine;

3) a first product in the parent vending machine and a number of (associated) products in the child vending machine; and

4) a first product in the child vending machine and a number of (associated) products in the parent vending machine.

The child vending machine 510 is configured to transmit vending operation information to the parent vending machine 505 via communication link 515. The vending operation information includes, but is not limited to, current inventory, vend tray status, vending machine status, vend operation status, and other vending machine related information as is known in the art. The child vending machine 510 can send the vending operation information when the child vending machine 510 is initially coupled to the parent vending machine 505. Additionally, the child vending machine 510 can send the vending operation information periodically at specified intervals, at the initiation of a vending operation, at the completion of a vending operation, when queried by the parent vending machine, or any combination of the above.

One example of the triggering event can be the selection of a specified number of products. In such example, the parent vending machine 505 is configured to request vending operation information after “n” number of products have been selected. The “n” number of products may have been selected during one (1) transaction or over multiple transactions.

Another example of the triggering event can be a request from an operator requesting status to the parent vending machine 505 and child vending machine 510. In such example, the operator sends a status request to the parent vending machine 505. In response, the parent vending machine 505 sends a request for vending operation information from the child vending machine 510. The parent vending machine 505 is operable to format the information and send a status response message to the operator.

In some embodiments, the parent vending machine 505 maintains a record of the vending operation information in the memory 454 of the parent vending machine 505. The parent vending machine 505 is configured to adjust the vending operation information in response to a vending operation. For example, if the consumer selects a product located in the child vending machine 510, the parent vending machine 505 is operable to adjust a quantity of the selected product that is stored in the memory 454 of the parent vending machine 505 as part of the vending operation information associated with the child vending machine 510.

The parent vending machine 505 further is operable to maintain a list of associated products in memory 454. The list of products may be maintained in a database, electronic table, tree structure listing, or any other record management means as is known in the art. The list of associated products includes a group (one or more) of products in the child vending machine 510 associated with each product located in the parent vending machine 505. The group of products associated with each product may be the same for every product in the parent vending machine 505 or the group of products associated with each product may differ from product to product in the parent vending machine 505. Additionally, the list of associated products may include a group of products in the parent vending machine 505 associated with each product located in the child vending machine 510. The group of products associated with each product may be the same for every product in the child vending machine 510 or the group of products associated with each product may differ from product to product in the child vending machine 510. Further, a product and one or more of the products in the group of products are associated with that product may be located in the same vending machine 505 or 510. For example, a first product located in the child vending machine 510 may be associated with a second product in the child vending machine 510.

The list of products also includes a corresponding discount associated with each product in the group of products. The discount may be the same for each product or the discount may differ from product to product in the group of products. Further, the difference in the discounts per product and associations per product may result in a particular product being discounted more when associated with specified products than when associated with other products.

For example, a group of products in the child vending machine 510 may be associated with a Dr. Pepper® soda product located in the parent vending machine 505. The group of products includes a bag of Lay's® potato chips and bag of Rold Gold® pretzels. When a consumer purchases the Dr. Pepper® soda product, the bag of Lay's® potato chips may be discounted by ten (10) cents and the bag of Rold Gold® pretzels may be discounted by ten (10) cents. Similarly, another group of products may be associated with a Coca-Cola® soda product located in the parent vending machine 505. This other group of products may also include a bag of Lay's® potato chips and a bag of Rold Gold® pretzels. When a consumer purchases the Coca-Cola® soda product, the bag of Lay's® potato chips may be discounted by five (05) cents and the bag of Rold Gold® pretzels may be discounted by ten (10) cents. As such, the bag of Lay's® potato chips actually is discounted more when combined with the Dr. Pepper® soda product than when combined with the Coca-Cola® soda product.

The parent vending machine 505 is operable to calculate a discounted price of an associated product. The parent vending machine deducts a discount amount from the original product price to determine the discounted price of the associated product in a combo-vend operation. Thereafter, if the discounted price is input into the parent vending machine 505 as part of a combo-vend operation, the parent vending machine 505 is operable to vend, or direct the child vending machine 510 to vend, the associated product.

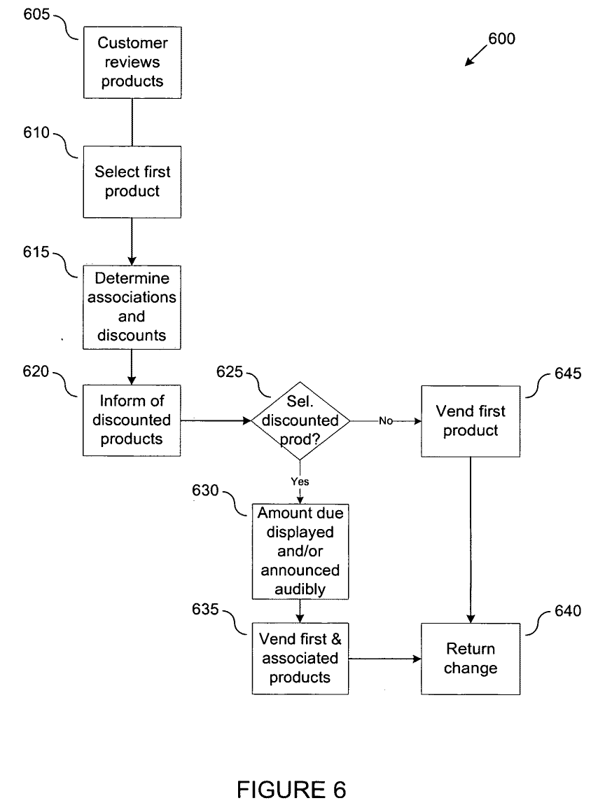

FIG. 6 illustrates an example combo-discount vend operation in accordance with the present disclosure. The embodiment shown in FIG. 6 is for illustration only, and other embodiments of the combo-discount vend operation 600 could be used without departing from the scope of this disclosure.

A customer reviews a group of products available for purchase (or vending from either vending machine 505 and/or 510) (step 605). The consumer may view the group of products via a window into the product display and storage area 102. Alternatively, in embodiments where no window is provided to the product display and storage area 102, the consumer may view a listing of the products available for purchase, such as, but not limited to, graphical images of the products available, text stating the products available, digital text and images, or any combination of the above.

After reviewing which products are available, the customer selects a snack product located in the child vending machine 510 by depressing button combinations, in the keypad 225 of the parent vending machine 505, corresponding to the desired snack product (step 610). The customer inserts money into the parent vending machine 505 in an amount sufficient to pay for the selected snack product. The customer may utilize coin money, paper currency, a credit card, or any combination of the above by inserting a credit card into the credit validator, a dollar bill into the bill validator, and/or a coin into the coin insert. It will be understood that the value of the dollar bill is exemplary and that various embodiments provide for the insertion of currency in other amounts that can be detected and determined by the bill validator.

The parent vending machine 505 determines that the selected snack product in the child vending machine 510 is associated with a group of beverage products located in the parent vending machine 505 and identifies the associated beverage products included in the associated group of beverage products (step 615). Specific discounts corresponding to each of the associated beverage products with the selected snack product are identified (or determined).

The customer of the selected snack product is informed of the associated beverage products and discounts (step 620). This is accomplished by providing a listing of those discounted beverage products to the customer. The listing of discounted beverage products includes one or more beverage products associated with the selected snack product. The listing also includes a discounted amount, or discount price, that is available to the customer as part of a combo-vend. For example, the listing can include a statement indicating that the discount is five (5) cents. The listing of discounted products may be visually displayed to the customer in the display 230 or conveyed using an audible alert, or voice, to inform the customer that discounted beverage products (and discounted amount/price) are available as part of the combo-vend.

In additional and alternative embodiments, one or both of the parent vending machine 505 and the child vending machine 510 include a dynamic display or sign, a permanent sign, or decal, or any other conventional, or hereinafter designed, means for conveying information to a customer, indicating that discounts for combo-vends (e.g., combination purchases from the vending machines 505, 510) are available. In yet additional and alternative embodiments, the child vending machine 510 informs the customer of the list of discounted products. In such embodiments, the child vending machine 510 may inform the customer of the discounted products in the same audible, or voice, alert, a listing of discounted products in a display, or a combination of the two.

The customer either selects a discounted beverage product or chooses not to select a discounted beverage product (step 625). The parent vending machine 505 is operable to receive an input for a discounted beverage product via the keypad 225. Additionally, the parent vending machine 505 is operable to inform the customer that the customer may decline purchasing a discounted product by depressing a specified key (e.g., the cancel key 330).

If the customer selects a discounted beverage product, the parent vending machine 505 displays (display 230), the amount due for the selected beverage product (step 630). In some embodiments, the parent vending machine 505 also informs the customer of the amount due via an audible voice. The amount due corresponds to a discounted price (e.g., original price minus discounted amount) of the discounted beverage product. In some embodiments, if the customer initially input additional money than is required to purchase the snack product (e.g., the first product); the parent vending machine 505 is operable to apply the excess of the initially input money to the amount due for the selected beverage product. In such embodiments, the parent vending machine 505 informs the customer of the remaining amount due.

After the customer makes a discounted beverage product selection and inserts the additional amount due, the parent vending machine 505 dispenses the selected beverage product (step 635). The customer may insert a credit card into the credit validator, a dollar bill into the bill validator, and/or a coin(s) into the coin insert. Additionally, the parent vending machine 505 instructs the child vending machine 510 to vend the selected snack product by sending a vend command to the child vending machine 510. The vend command includes an indicator identifying which product is to be dispensed and/or a command to operate mechanism to dispense the selected snack product. Thereafter, the parent vending machine returns any change (e.g., money input in excess of the amount due) to the customer (step 640).

If the customer declines to purchase the discounted beverage, the parent vending machine 505 does not vend any associated products therefrom and instructs the child vending machine 510 to vend the selected snack product. Thereafter, the parent vending machine returns any change (e.g., money input in excess of the amount due) to the customer (step 640).

In some embodiments, the parent vending machine instructs the child vending machine 510 to vend the selected snack product prior to, or concurrently with, informing the customer of the listing of discounted beverage products. In such embodiments, the parent vending machine 505 may store in memory 454 the discounted prices corresponding to each discounted beverage product, and may store them until a completion event occurs. A completion event be one or more of a specified duration of time, a customer request for change due (e.g., by depressing the coin return key 332), or the customer declining purchase of the discounted beverage (e.g., associated) product.

It will be understood that illustration of the first product as a snack product from the child vending machine 510 and the associated product from the parent vending machine 505 is for example purpose only. Other examples of the combo-vend process could be used without departing from the scope of this disclosure. For example, the first product can be located in the parent vending machine 505 and the associated product located in the child vending machine 510. The combo-discount vend operation can be:

1) a first product in the parent vending machine and a second (associated) product in the child vending machine;

2) a first product in the child vending machine and a second (associated) product in the parent vending machine;

3) a first product in the parent vending machine and a number of (associated) products in the child vending machine; and

4) a first product in the child vending machine and a number of (associated) products in the parent vending machine.

In one embodiment, the parent vending machine 505 is configured to only provide a discount when the first product is located in the parent vending machine 505 and the associated product is located in the child vending machine 510. In another embodiment, the parent vending machine 505 is configured to only provide a discount when the first product is located in the child vending machine 510 and the associated product is located in the parent vending machine 505. Other configurations are possible.

In additional and alternative embodiments, the parent vending machine 505 is configured to offer a discount for more than one product associated with the first product. In such embodiment, the parent vending machine 505 is operable to continue to offer discounts for additional products from the group of products associated with the first products after the selection of an associated product. For example, after the customer selects a beverage located in the parent vending machine 505, the parent vending machine 505 offers discounts for a group of snacks available in the child vending machine 510. Then, the customer selects a discounted snack from the group of snacks. Thereafter, the parent vending machine 505 again offers discounts for a group of snacks available in the child vending machine 510. This process can repeat until a completion event occurs. In some embodiments, products located in the same vending machine 505, 510 as the first product are also included in the group of products associated with the first product (e.g., using the previous example, one or more beverages located in vending machine 505 may be included in a listing of discounted products being offered). In some embodiments, the parent vending machine 505 is configured to offer a different, either higher or lower, discount in subsequent discount offers.

FIG. 7 is a schematic system diagram of a vending machine system 700 having wireless communication capability according to embodiments of the present disclosure. The embodiment of the vending machine system 700 shown in FIG. 7 is for illustration only, and other embodiments of the vending machine system 700 could be used without departing from the scope of this disclosure.

Parent vending machines 505, child vending machine 510 and vending machine 705 communicate with each other via a communications link 701a, 701b and 701c (wireless or wireline). Parent vending machine 505, child vending machine 510, and vending machine 705 can be the same general structure and functionality as the vending machine 100. In some embodiments, the vending machines 505, 510 and 705 are located adjacent to each other and only the parent vending machine 505 and the vending machine 705 have a user interface: e.g., coin/currency acceptor and/or dispenser mechanisms, selection buttons, and display apparatus. A user may select a product located in the child vending machine 510 by operating the selection buttons on the parent machine 505 and the parent vending machine 505 will send a message to the child vending machine 510 to cause the child vending machine 510 to dispense the product. Where the child vending machine 510 has a product delivery sensing system, the child vending machine 510 may send a message to the parent vending machine 505 indicating whether the product was successfully vended, and the parent vending machine 505 may offer the opportunity to select a discounted product or return the customer's money.

The vending machines 505, 510 and 705 may exchange setup information via messages. Such setup information may include numbers of shelves, numbers of product queues on each shelf, numbers of products in each queue, product price for each product queue, or other information. In an embodiment where only one machine has a user interface, such setup information may enable that machine to provide menu and selection choices for products in the other machines.

The machines 505, 510 and 705 may also exchange operational status information. Such operational status information may include current inventory in each product queue, cumulative count of number of activations of a product queue dispenser, time since last servicing call, required maintenance, detected electronic or mechanical failures, or other information.

Other devices may additionally or alternatively communicate with one or more of the vending machines 505, 510 and 705 via communication link 515 (wireless or wireline). A portable computer 710 communicates wirelessly with the parent vending machine 505 and may be used by a technician to provide setup information when the vending machines 505, 510 and/or 705 are installed, reconfigured or restocked. A technician in a service van 715 communicates wirelessly with the parent vending machine 505 from outside the building where the machine is located to determine whether service on one or more of the machines 505, 510 and 705 is required and, if so, what kind of service.

Where the facility in which the vending machines 505, 510 and 705 are located has a wireless access point 720, the parent vending machine 505 communicates wirelessly through the access point 720 to a device 725 coupled to the access point 720 via a network 730 (e.g., Internet or another communication network). The device 725 may be a remotely located central server or other controller for an operator of a number of such vending machines. Through the use of a device 725, the operator may achieve a benefit such as avoiding the cost of sending a technician to the location of the vending machines 505, 510 and 705 to obtain operational status information.

In some embodiments, the vending machine 505 is capable of cellular communication. In such embodiments a personal digital assistant 735 (PDA) or other cellular-capable device may ‘call’ the parent vending machine 505 at its cellular phone number to establish wireless communication via a base station 740 in order to send setup information or receive operational status information. Similarly, the base station 740 may be coupled to the network 730, allowing the device 725 to communicate with the parent vending machine 505 via the base station 740.

Communications between the parent vending machine 505 and any one or more of the portable computer 710 the wireless access point 720, and the vehicle 715 may be accomplished in accordance with a wireless communications protocol such as the IEEE 802.11 standard (referred to as a “WiFi standard”), the IEEE 802.16 standard (referred to as a “WiMAX standard”), or any other suitable wireless communications interface standard. The vending machines 505, 510 and 705 may form a wireless ad hoc network or other mesh network. In other embodiments, communication between the parent vending machine 505 and the base station 740 may be conducted under another standard than a cellular wireless standard.

While only the parent vending machine 505 is shown communicating with the portable computer 710 the wireless access point 720, and the vehicle 715, it will be understood that any or all of the vending machines 505, 510 and 705 may engage in such communication. In embodiments where setup and/or operational status information are located in the parent vending machine 505, another machine, such as vending machine 705, may provide communication (wireless or wireline) (not shown) to an external device, such as the portable computer 710. In such an embodiment, status information is communicated from the parent vending machine 505 to the vending machine 705 and then communicated (wireless or wireline) to the portable computer 710. Similarly, setup commands and information are communicated from the portable computer 710 to the vending machine 705 and then communicated to the parent vending machine 505. In one or more embodiments, these communications are wireless.

In some embodiments, an operator may purchase product inventory to stock in the vending machines. In other embodiments, an operator may purchase and install machines that a manufacturer or other entity uses for consignment sales. Where such consignment products have a high price, cash sales may be impractical and the vending machine may be equipped with a card reader to scan credit or debit cards to fund the transaction. The vending machine utilizes wired or wireless communication to communicate with a transaction network, independent sales organization, acquiring bank, or other entity to authorize the transaction.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A vending machine system comprising:
a first vending machine, said first vending machine capable of vending one or more products of a first group of products from a first vending machine product area; and
a second vending machine coupled to said first vending machine, said second vending machine capable of vending one or more products of a second group of products from a second vending machine product area in response to commands received from said first vending machine,
wherein said first vending machine is configured to discount at least one product in at least a one of said first group of products and said second group of products when another product is selected by a customer from at least a one of of said first group of products and said second group of products.

2. The system of claim 1, wherein said first vending machine is configured to determine associations between products in said first group of products and said second group of products.

3. The system of claim 1, wherein said first vending machine is configured to determine a discount amount to discount said at least one product.

4. The system of claim 1, wherein said first vending machine is configured to inform a customer of said discount of said at least one product.

5. The system of claim 4, wherein said first vending machine displays at least one of a discount price for said at least one product and an amount said at least one product is discounted.

6. The system of claim 1, wherein said first vending machine determines a first discount price for a first product associated with said associated product and a second discount price for a second product associated with said associated product.

7. The system of claim 1, wherein said first vending machine is configured to apply an excess amount received for a purchase of said associated product to a purchase of said at least one product.

8. An apparatus for vending products to a consumer, the apparatus comprising:
a product storage area;
a computer readable medium; and
a plurality of instructions wherein at least a portion of said plurality of instructions is storable in the computer readable medium, and further when a first product is selected, wherein the plurality of instructions is configured to cause the apparatus to:
discount a price of an associated product located in at least one of the product storage area and a remote product storage area.

9. The apparatus of claim 8, wherein the plurality of instructions further is configured to cause the apparatus to determine associations between products in the product storage area and products in the remote product storage area.

10. The system of claim 8, wherein the plurality of instructions further is configured to cause the apparatus to determine a discount price corresponding to the associated product.

11. The system of claim 8, wherein the apparatus is configured to inform a customer of the discount of the associated product.

12. The system of claim 11, wherein the apparatus further comprise a display capable of displaying at least one of a discount price for the associated product and an amount the associated product is discounted.

13. The system of claim 8, wherein the plurality of instructions further is configured to cause the apparatus to determines a first discount price for a first associated product associated with the first product and a second discount price for a second associated product associated with the first product.

14. The system of claim 8, wherein the plurality of instructions further is configured to cause the apparatus to apply an excess amount received for a purchase of the first product to a purchase of the associated product.

15. A method for vending products, the method comprising:
receiving a selection for a first product;
determining a group of products associated to the first product, the group of products including at least one product;
identifying a discount corresponding to each product within the group products;
offering at least one of the group products at a discounted price when purchased with said first product.

16. The method of claim 15, wherein the first product is located in a first vending machine and the group of products is located in a second vending machine.

17. The method of claim 16, wherein the first vending machine directs the second vending machine to vend at least one product from the group of products.

18. The method of claim 15, wherein the step of offering comprises displaying at least one of a discount amount or discount price for the at least one of the group of products.

19. The method of claim 15, wherein the step of identifying further comprises identifying a first discount corresponding to a first product of the group of products and a second discount corresponding to a second product of the group of products.

20. The method of claim 15, further comprising applying an excess amount received for a purchase of the first product to a purchase of the at least one of the group products.
